(19) United States
(12) Patent Application Publication
(10) Pub. No.: US 2022/0358267 A1
(43) Pub. Date: Nov. 10, 2022

(54) ADAPTING A PRODUCTION PROCESS FOR COMPONENTS OF A COMPONENT GROUP

(71) Applicant: Carsten Schuh, Baldham (DE)

(72) Inventor: Carsten Schuh, Baldham (DE)

(21) Appl. No.: 17/624,251

(22) PCT Filed: Jun. 24, 2020
(86) PCT No.: PCT/EP2020/067646

§ 371 Date: Dec. 30, 2021

(30) Foreign Application Priority Data
Jul. 3, 2019 (DE) 10 2019 209 772.3

(51) Int. Cl. G06F 30/27; G06Q 50/04; G05B 19/4097

(52) U.S. Cl. CPC G06F 30/27; G06Q 50/04; G05B 19/4097; G06F 2119/18

(57) ABSTRACT

The invention relates to adapting a process for producing components of a component assembly, wherein, during the production process of a first component of the component assembly, a real digital model (15) of the first component is provided with information regarding design, production, actual geometry (5), field usage, repair and/or recycling of the first component and is updated, comprising the steps of:—acquiring (S1) specifications (11) for the components of the component assembly;—creating (S2) a CAD model (12) for manufacturing the first component according to the specifications (11);—creating (S3) the real digital model (15);—adapting (S4) the real digital model (15) on the basis of first information obtained as a result of creating (S2) the CAD model (12);—manufacturing (S5, 13) the first component according to the CAD model (12);—adapting (S6) the real digital model (15) on the basis of second information obtained as a result of manufacturing (S5, 13) the first component;—comparing (S7) the real digital model (15) with the specifications (11) for the components of the component assembly;—adapting (S8) the CAD model (12) taking into account the comparison (S7) and additional parameters; and—using (S9) the adapted CAD model (12) for further manufacturing of the components of the component assembly.

This application is the National Stage of International Application No. PCT/EP2020/067646, filed Jun. 24, 2020, which claims the benefit of German Patent Application No. DE 10 2019 209 772.3, filed Jul. 3, 2019. The entire contents of these documents are hereby incorporated herein by reference.

### BACKGROUND

### Field

The present embodiments relate to adapting a production process for components of a component group.

### Description of the Prior Art

The process sequence along the digital production chain for a component is currently geared to a linear, controlled value stream (e.g., computer-aided design (CAD)/computer-aided manufacturing (CAM) -> production -> computer-aided quality (CAQ)), which has no provision for feedback or control loops.

Today, the occurrence of production and quality problems results in Engineering being informed, which then makes decisions about modification/adaptation of individual process acts, adapts the materials or the tools used, contacts the customer regarding a change of job description, or issues special approvals.

CAD design of a component may include geometric and materials data, details relating to surface finish, quality specifications, PMIs, which contain additional features and critical to quality (CTQs), and, if necessary, further information (e.g., process sequence, standards, tools and aids to be used, etc.) important to production of the component in accordance with the customer specification.

A digital real model is defined below as a comprehensive digital reproduction of a component along the value chain or the lifecycle (e.g., product lifecycle) at the time x (e.g., along CAD/CAM, production, field use, if necessary, repair, through to recycling or scrapping). The 3D real model contains all information essential to the component over its lifecycle, beginning with the CAD model, all (CTQ-)relevant materials data and production data (e.g., material batch, material history, details relating to the individual process acts, such as machine, worker, tools, including history thereof, real geometries, particular incidents, rework), quality-relevant data (e.g., including history, details relating to performance, performing persons), storage periods, field use (e.g., including details relating to installation location and stresses and strains over lifespan), if necessary, inspection data, repair, and second use, etc.

### SUMMARY AND DESCRIPTION

The scope of the present invention is defined solely by the appended claims and is not affected to any degree by the statements within this summary

The present embodiments may obviate one or more of the drawbacks or limitations in the related art. For example, an alternative production process for components is provided.

One aspect is to provide a method that records an entire production process using a digital real model and makes changes in the production process as soon as deviations are detected between an actual state and a setpoint state.

The present embodiments include a method for adapting a production process for components of a component group, where during the production process for a first component of the component group, a digital real model of the first component is provided and updated. The digital real model contains information concerning design, production, actual geometry, field use, repair, and/or recycling of the first component. The method includes recording requirements for the components of the component group. A CAD model is created for manufacturing the first component in accordance with the requirements. The digital real model is created. The digital real model is adapted based on first information obtained through the creation of the CAD model. The first component is manufactured in accordance with the CAD model. The digital real model is adapted based on second information obtained through the manufacture of the first component. The digital real model is compared with the requirements for the components of the component group. The CAD model is adapted in light of the comparison and further parameters. The adapted CAD model is used for the further manufacture of the components of the component group.

The production process includes the entire process from the planning of production (e.g., recording of requirements) through to manufacture of the first component and further manufacture of the components of the component group.

The adapting of the CAD model may result either in a CAD model that may be manufactured in a process-reliable manner using the machines, tools, aids, and processes that have been used to date, or in modification of the process chain and execution. The adapting may therefore result in deviations from the requirements for the components of the component group being allowed. This has the advantage that it is thus possible to find an optimum between customer requirements (e.g., requirements) and possibilities of the production process.

The digital real model exists for the entire life (e.g., lifecycle, value chain, product cycle) and during the entire production process for the components.

In a further configuration, the digital real model of the first component may be provided and updated continuously (e.g., continually/constantly) or at predefined times.

In a further configuration, the CAD model may contain data relating to geometry, materials, surface finish, quality specifications, sequence of the production process, standards, tools to be used, and/or aids to be used.

In a further configuration, the requirements for the components may be recorded from customer specifications, customer requirements, a requirements specification, and/or a job description.

In a further configuration, the requirements for the components may contain information relating to the function, the tolerances, the life, and/or the price of the components.

In a further configuration, the comparison of the digital real model with the requirements for the components may be performed during the manufacture and/or following completion of the manufacture as part of an examination or inspection.

The examination or inspection may be performed by an automated method. The automated method may include sensor measurements, where results of the sensor measurements are compared with setpoint values.

In a further configuration, the CAD model may be adapted by a dynamic control loop.

One possible embodiment of a control loop is provided in FIG. 2.

In a further configuration, the further parameters for adapting the CAD model may include the requirements for the components.

In a further configuration, the further parameters for adapting the CAD model may include information from simulations. The simulation may involve using, for example, a finite element method and a correlation of existing stresses and strains compared with load ratings, flow models, life forecasts, etc.

In a further configuration, the further parameters for adapting the CAD model may be optimized using knowledge gained during the production process.

In a further configuration, the knowledge gained during production processes to date may be taken into account in a form optimized by machine learning in order to adapt the CAD model.

The method according to the present embodiments has the following advantages compared to the prior art: high flexibility with regard to the component to be produced and design of the component; robust, resilient, adaptive, but also quickly reconfigurable, process chain; high productivity (e.g., cost efficiency, utilization level) and low failure cost rate for existing process lines, tools, and aids; and learning and self-optimizing system (e.g., machine learning, artificial intelligence) as an integral part of a cyberphysical production system (CPS).

### BRIEF DESCRIPTION OF THE DRAWINGS

FIG. 1 shows a flowchart for a method according to an embodiment;

FIG. 2 shows a general control loop; and

FIG. 3 shows a sequence of a method according to another embodiment.

### DETAILED DESCRIPTION

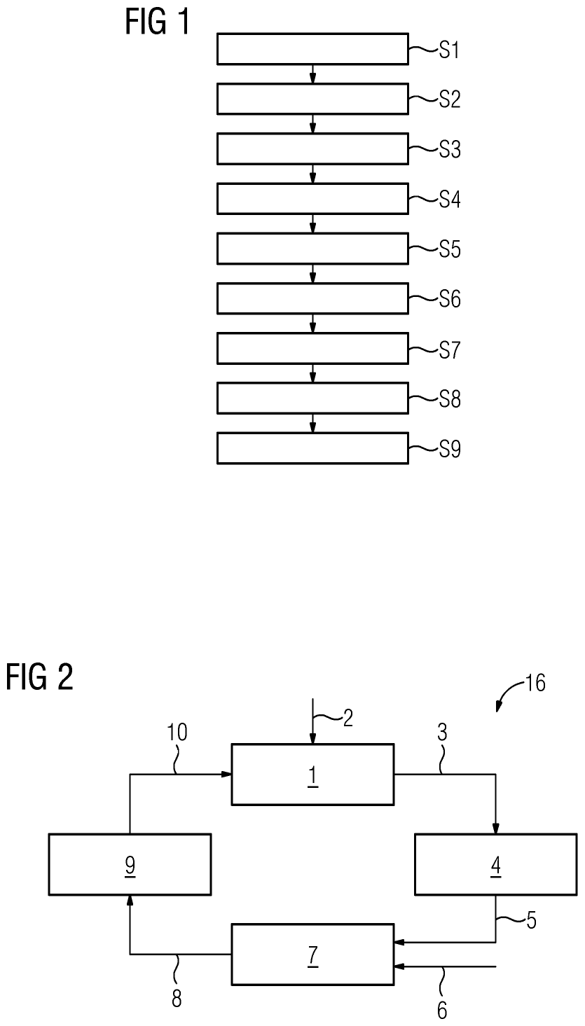

FIG. 1 shows a flowchart for a method according to the present embodiments for adapting a production process for components of a component group. During the production process for a first component of the component group, a digital real model of the first component is provided and updated. The digital real model contains information concerning design, production, actual geometry, field use, repair, and/or recycling of the first component.

The method includes the following acts—Act S1: recording requirements for the components of the component group; act S2: creating a CAD model for manufacturing the first component in accordance with the requirements; act S3: creating the digital real model; act S4: adapting the digital real model based on first information obtained through the creation of the CAD model; act S5 manufacturing the first component in accordance with the CAD model; act S6: adapting the digital real model based on second information obtained through the manufacture of the first component; act S7: comparing the digital real model with the requirements for the components of the component group; act S8: adapting the CAD model in the light of the comparison and of further parameters; and act S9: using the adapted CAD model for the further manufacture of the components of the component group.

FIG. 2 shows a general control loop 16. In one configuration of the method according to the present embodiments, the CAD model may be adapted within a dynamic control loop based on information obtained through the production of the first component (of the component group). The control loop has a controlled system 1. The controlled system 1 may, for example, be a production process, a manufacturing process, and/or a processing process for the first component in a machine. The controlled system 1 may be affected by disturbance variables 2. Disturbance variables 2 may, for example, be material variances/tolerances in the raw material for the first component. The controlled system 1 is intended to be used by the control loop to control a controlled variable 3. The controlled variable 3 may, for example, be dimensions of the first component. The controlled variable 3 is recorded by a measuring device 4. The measuring device 4 may, for example, have sensors that pick up the first component during the production process and may be mounted on the machine that produces the first component. The result of the recording by the measuring device 4 is an actual value 5. In the example, the actual value 5 is the actual geometry and part of a digital real model. The actual value 5 is compared with an externally provided/defined setpoint value 6. The setpoint value 6 may, for example, contain requirements for the dimensions of the components of the component group. Results of the comparison are forwarded to a controller 7. The controller 7 may, for example, be a computer program. The controller 7 controls a control variable 8. The control variable 8 may, for example, be the CAD model (e.g., based on which the first component was produced). The control variable 8 controls a control device 9. The control device 9 may, for example, be the machine controller of the machine. The control device sets a manipulated variable 10. The manipulated variable may, for example, be a machine parameter such as drilling diameter and/or milling speed. The controlled (e.g., altered) manipulated variable 10 may be used on the controlled system 1 in the further stages of the sequence in order to produce further components of the component group.

The components of the control loop 16 from FIG. 2 are associated with a further exemplary embodiment below. A predefined customer specification (e.g., setpoint value 6) and a CAD model based thereon (e.g., control variable 8) are taken as a basis for manufacturing a first component of a component group having walls (e.g., controlled variable 3) that are supposed to have a certain material thickness, including tolerance (e.g., setpoint value 6). In the course of the machining production process (e.g., controlled system 1), it becomes clear that these walls (e.g., controlled variable 3) cannot be produced within the specified tolerances (e.g., setpoint value 6) in a process-reliable manner on account of disturbance variables 2 (e.g., the digital real model (actual value 5) of the first component that was created in the course of a process step (online) or during the subsequent geometric measurement by a measuring device 4 (offline) shows a significant deviation from the target dimensions (setpoint value 6)). A mechanism (e.g., automatic mechanism; controller 7) then intervenes. Based on the predefined customer specifications (e.g., setpoint value 6), the mechanism either attempts, by adapting the CAD model (e.g., control variable 8, adapting material or geometries, such as radii, wall thicknesses, tolerances, surface roughnesses, etc.), if necessary with the aid of suitable simulation models (e.g., finite element method for correlation of stresses and strains versus load ratings, flow models, life forecasts, etc.), of CAM simulations and based on experiences gained during production (e.g., machine learning), to create a design (e.g., CAD model) that may be manufactured in a process-reliable manner using the machines (e.g., manipulated variable 10), tools (e.g., manipulated variable 10), aids (e.g., manipulated variable 10), and processes (e.g., manipulated variable 10) used to date or makes suggestions for suitably modifying the process chain and execution (e.g., including manipulated variables 10 through intervention by the control device 9). The adapted CAD model (e.g., control variable 8) and/or the modified process chain and execution (e.g., manipulated variable 10) may be used on the controlled system 1 in the further stages of the sequence in order to produce further components of the component group.

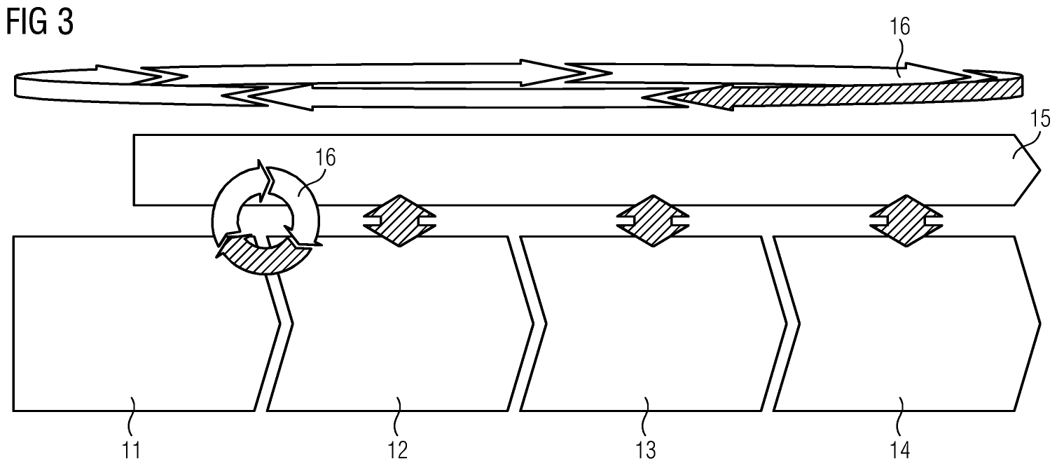

FIG. 3 shows a possible sequence of the method according to the present embodiments for adapting a production process for components of a component group. Requirements 11 for the components of the component group (e.g., customer specifications, requirements specification, job description) are recorded. The requirements 11 are taken as a basis for creating a CAD model 12. The CAD model 12 is taken as a basis for carrying out the manufacture 13. The manufacture 13, or results of the manufacture 13, subsequently undergoes, or undergo, an examination/inspection 14. Throughout the method, a digital real model 15 is provided and updated. A control loop 16 (e.g., dynamic control loop) may intervene and adapt the CAD model 12 at any time (e.g., in the event of deviation between setpoint and actual values). The adaptation of the CAD model 12 also adapts the manufacture 13. Deviations from the requirements 11 are permitted in this case. Further components of the component group may be produced based on the adaptations.

The aim is to adapt the CAD model in order to create a CAD model that may be manufactured in a process-reliable manner using the machines, tools, aids and processes that have been used to date or in order to create an implementable new process chain and execution. The adapting may therefore result in deviations from the requirements for the components of the component group being allowed. This has the advantage that it is thus possible to find an optimum between customer requirements (e.g., requirements) and possibilities of the production process.

In order to be able to react to manufacturing or quality problems promptly and effectively, the introduction of control loops 16 between manufacture 13 and the component design (e.g., CAD model 12) within the digital chain is to be provided.

According to the present embodiments, a control loop 16 (e.g., online or offline) that is made up of requirements 11 for a component (e.g., predefined customer specifications, requirements specification/job description), the CAD model 12, and the digital real model 15 along the production process, (e.g., with focus on the manufacture 13) is provided.

Although the invention has been illustrated and described more thoroughly with reference to the exemplary embodiments, the invention is not limited by the disclosed examples, and other variations may be derived therefrom by a person skilled in the art without departing from the scope of protection of the invention.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for adapting a production process for components of a component group, the method comprising:
providing and updating a digital real model of a first component of the component group during the production process for the first component, wherein the digital real model includes information related to design, production, actual geometry, field use, repair, recycling, or any combination thereof of the first component;
comprising the following steps:
recording requirements for the components of the component group;
creating a CAD model for manufacturing the first component in accordance with the requirements;
creating the digital real model;
adapting the digital real model based on first information obtained through the creation of the CAD model;
manufacturing the first component in accordance with the CAD model;
adapting the digital real model based on second information obtained through the manufacture of the first component;
comparing the digital real model with the requirements for the components of the component group;
adapting the CAD model based on the comparison and further parameters; and
using the adapted CAD model for the further manufacture of the components of the component group.

2. The method of claim 1, wherein the digital real model of the first component is provided and updated continuously or at predefined times.

3. The method of claim 1, wherein the CAD model includes data relating to geometry, materials, surface finish, quality specifications, sequence of the production process, standards, tools to be used, aids to be used, or any combination thereof.

4. The method of claim 1, wherein the requirements for the components are recorded from customer specifications, customer requirements, a requirements specification, a job description, or any combination thereof.

5. The method of claim 1, wherein the requirements for the components include information relating to function, tolerances, life, price, or any combination thereof of the components.

6. The method of claim 1, wherein the comparison of the digital real model with the requirements for the components is performed during the manufacture, following completion of the manufacture as part of an examination or inspection, or during the manufacture and following completion of the manufacture as part of the examination or inspection.

7. The method of claim 1, wherein the CAD model is adapted within a dynamic control loop.

8. The method of claim 1, wherein the further parameters for adapting the CAD model include the requirements for the components.

9. The method of claim 1, wherein the further parameters for adapting the CAD model include information from simulations.

10. The method of claim 1, wherein the further parameters for adapting the CAD model are optimized using knowledge gained during the production process.

11. The method of claim 10, wherein the knowledge gained during production processes to date is taken into account in a form optimized by machine learning in order to adapt the CAD model.

12. The method of claim 2, wherein the CAD model includes data relating to geometry, materials, surface finish, quality specifications, sequence of the production process, standards, tools to be used, aids to be used, or any combination thereof.

13. The method of claim 12, wherein the requirements for the components are recorded from customer specifications, customer requirements, a requirements specification, a job description, or any combination thereof.

14. The method of claim 13, wherein the requirements for the components include information relating to function, tolerances, life, price, or any combination thereof of the components.

15. The method of claim 14, wherein the comparison of the digital real model with the requirements for the components is performed during the manufacture, following completion of the manufacture as part of an examination or inspection, or during the manufacture and following completion of the manufacture as part of the examination or inspection.

16. The method of claim 15, wherein the CAD model is adapted within a dynamic control loop.

17. The method of claim 16, wherein the further parameters for adapting the CAD model include the requirements for the components.

18. The method of claim 17, wherein the further parameters for adapting the CAD model include information from simulations.
